(19) United States
(12) Patent Application Publication
(10) Pub. No.: US 2005/0208271 A1
(43) Pub. Date: Sep. 22, 2005

(54) Bonding method for micro-structured polymers

(76) Inventors: Rainer J. Fasching, Mill Valley, CA (US); WonHyoung Ryu, Stanford, CA (US); Friedrich B. Prinz, Woodside, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/083,679

(22) Filed: Mar. 16, 2005

Related U.S. Application Data
(60) Provisional application No. 60/554,201, filed on Mar. 17, 2004.

(51) Int. Cl. B32B 3/00

(52) U.S. Cl. 428/156; 156/308.6

(57) ABSTRACT

Solvent bonding by exposure to a solvent vapor is provided. Vapor phase solvent bonding provides accurate and precise control of the amount of solvent provided to the polymer bodies or objects being bonded. Such precision control of solvent quantity enables solvent bonding to be performed in a manner that does not damage or destroy micro-patterns present in the polymer bodies being bonded. Vapor solvent bonding can be performed in two regimes: saturated and linear. In the saturated regime, the temperature of a polymer body surface is less than the condensation temperature of a polymer vapor. Thus, a liquid condensate will tend to form in this regime. In the linear regime, the temperature of a polymer body surface is greater than the condensation temperature of the polymer vapor. Although a liquid condensate will not form, bonding can still be performed.

### CROSS REFERENCE TO RELATED APPLICATIONS

This application claims the benefit of U.S. Provisional Application 60/554,201, filed Mar. 17, 2004, entitled “3-D Interconnected Multi-Layer Microstructure of Thermoplastic Materials”, and hereby incorporated by reference in its entirety.

### FIELD OF THE INVENTION

This invention relates to solvent bonding of polymers.

### BACKGROUND

Three-dimensionally patterned polymer structures are presently of interest for various applications (e.g., biological and medical applications). Methods for fabricating such structures have therefore received attention in the art. For example, US 2003/0183982 considers formation of such structures by a three-dimensional printing process. Another example is provided by US 2002/0182241, which considers formation of three-dimensional patterned polymer structures by bonding two-dimensionally patterned polymer layers together. Various bonding techniques are mentioned in this work, including solvent bonding, thermal bonding and plasma bonding.

These bonding methods are well known in the art, and accordingly are not discussed in detail in US 2002/0182241. For example, US 2004/0112518 considers plasma bonding, U.S. Pat. No. 6,652,942 considers solvent bonding, and U.S. Pat. No. 4,258,093 considers thermal bonding. Bonding of patterned polymer layers to create microchannel heat exchangers is considered in U.S. Pat. No. 6,827,128. In this work, thermal bonding is preferred, and it is indicated that solvent bonding is unsuitable. Although it is not stated in this reference why solvent bonding is unsuitable, it is likely that these workers found conventional solvent bonding processes degrade or destroy small features in the micro-patterned layers.

Many variants of solvent bonding are known in the art. For example, U.S. Pat. No. 5,848,811 considers a self-limiting solvent bonding process to more precisely control application of solvent to parts to be bonded. In U.S. Pat. No. 4,651,382 application of a solvent to parts with a syringe is considered. Another example is provided by U.S. Pat. No. 4,595,446, where application of a solvent as a liquid spray mist is considered. A further example is U.S. Pat. No. 4,512,947, which considers a specialized applicator for solvent application. Yet another example is U.S. Pat. No. 4,256,524, which considers application of a solvent followed by heat and/or pressure to activate the solvent and form a solvent bond.

However, none of these solvent bonding approaches addresses the problem of solvent bonding polymer bodies that have small (e.g., microscopic) features which can easily be damaged by solvent bonding. Accordingly, it would be an advance in the art to provide solvent bonding of micro-patterned polymer objects that does not damage the micro-patterns.

### SUMMARY

The present invention provides solvent bonding by exposure to a solvent vapor. Vapor phase solvent bonding provides accurate and precise control of the amount of solvent provided to the polymer bodies or objects being bonded. Such precision control of solvent quantity enables solvent bonding to be performed in a manner that does not damage or destroy micro-patterns present in the polymer bodies being bonded. Vapor solvent bonding can be performed in two regimes: saturated and linear. In the saturated regime, the temperature of a polymer body surface is less than the condensation temperature of a polymer vapor. Thus, a liquid condensate will tend to form in this regime. In the linear regime, the temperature of a polymer body surface is greater than the condensation temperature of the solvent vapor. Although a liquid condensate will not form, the polymer surface will be softened by absorbing solvent molecules out of the vapor phase and therefore bonding can still be performed.

### BRIEF DESCRIPTION OF THE DRAWINGS

FIG. 1 shows a solvent bonding method according to an embodiment of the invention.

FIG. 2 shows apparatus for polymer solvent bonding according to an embodiment of the invention.

FIGS. 3a-c show examples of micro-patterned polymers exposed to solvent according to embodiments of the invention.

FIGS. 4a-b show an example of polymer bonding according to an embodiment of the invention.

FIG. 5 shows a polymer structure having layers with inclusions and bonded according to an embodiment of the invention.

### DETAILED DESCRIPTION

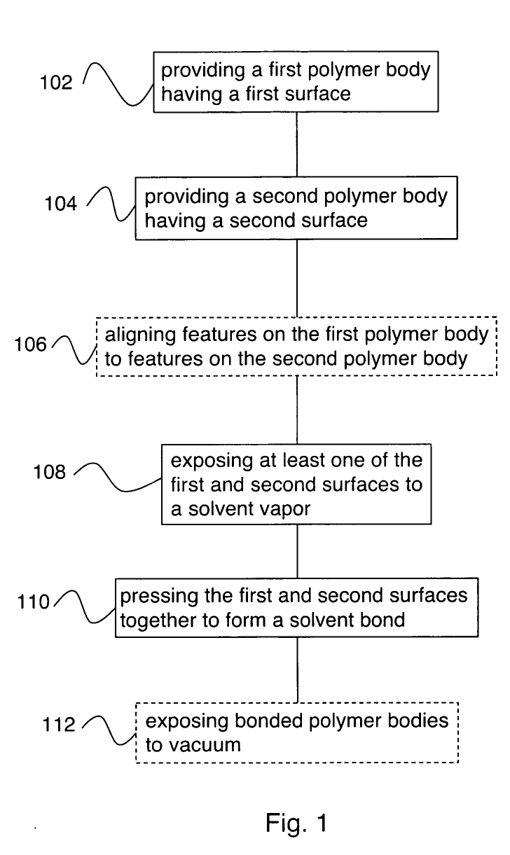

FIG. 1 shows a solvent bonding method according to an embodiment of the invention. Step 102 is providing a first polymer body having a first surface. Similarly, step 104 is providing a second polymer body having a second surface. Step 108 entails exposing either (or both) of the first and second surfaces to a solvent vapor. Step 110 is pressing the two surfaces together (after exposure to the solvent vapor) in order to form a solvent bond. Optionally, step 106 of aligning features on the two polymer bodies to each other can be performed prior to the exposing of step 108. This aligning can be performed inside or outside a bonding chamber. Preferably, this aligning is performed outside the bonding chamber using any convenient method (e.g., as known from wafer alignment and bonding technology). Also optionally, step 112 of exposing the bonded polymer bodies to vacuum (in order to remove remaining solvent vapor) can be performed after the pressing of step 110. A key aspect of the invention is exposure to a solvent vapor as a method for precisely controlling the delivery of solvent to polymer. Accordingly, this aspect of the invention will be described in detail first, followed by a description of other aspects of the invention.

Exposure of a surface of a polymer body to a solvent vapor can take place in either of two regimes: saturated or linear. In the saturated regime, the temperature of the surface of the polymer body is less than or equal to the condensation temperature T_{c} determined by the partial pressure of the solvent vapor and its chemical composition. Therefore, in the saturated regime, a liquid condensate of solvent tends to form on the surface of the polymer body, since the solvent vapor is saturated (or super-saturated) at the temperature of the polymer surface. The condensation temperature as a function of partial pressure is known for many solvent vapors and can readily be determined by routine measurements if necessary.

In the linear regime, the temperature of the surface of the polymer body is above the condensation temperature T_{c} and the absorbed amount of solvent is proportional to the partial pressure of the solvent vapor. Accordingly, a liquid solvent condensate will not tend to form on the surface of the polymer, since the solvent vapor is unsaturated at the temperature of the polymer surface but solvent molecules will be absorbed by the polymer. Even though a liquid condensate is not formed on the surface, such exposure can soften polymer body surfaces sufficiently for formation of a solvent bond.

Generally, more solvent is deposited on polymer body surfaces in the saturated regime than in the linear regime. Accordingly, exposure in the saturated regime is preferred for polymer-solvent combinations requiring a relatively large amount of solvent to form the bond. Exposure in the linear regime is preferred for polymer-solvent combinations requiring a relatively small amount of solvent to form the bond. Further process design flexibility is afforded by setting the polymer bodies being bonded to the same temperature or to different temperatures. If the two bodies are at the same temperature, then the solvent vapor exposure is in the same regime (i.e., saturated or linear) at both polymer bodies. If the two polymer bodies are at different temperatures, then the solvent vapor exposure can be in different regimes at the polymer bodies.

The invention can be practiced with any polymer-solvent combination capable of solvent bonding. The polymer bodies being bonded can have the same composition or can have different compositions. Although most of the examples given herein show bonding of two bodies, the invention is also applicable to simultaneous or sequential bonding of three or more polymer bodies. Suitable polymers for practicing the invention include: poly methyl methacrylates; polyethylene; polystyrene; nylons; polyester; polyurethane; polyterafluoroethylene; poly vinyl chloride; poly carbonate; polypropylene; poly vinyl alcohol; poly-lactide; poly-glycolide; poly-dioxanone (PDS); aliphatic poly-ester; poly-caprolactone; poly-anhydrides; poly ortho esters; alkali derivatives of trimethylenecarbonate; δ-valerolactone; β-butyrolactone; γ-butyrolactone; ε-decalactone; hydrocybutyrate; hydroxyvalerate; 1,4-dioxepan-2-one; 1,5,8,12-tetraoxacyclotetradecane-7,14-dione; 1,5-dioxepan-2-one; 6,6-dimethyl-1,4-diocan-2-one; and mixtures or co-polymers thereof.

Suitable solvents for practicing the invention include: 1,4-Dioxane (C₄H₈O₂); 1,1,1,3,3,3-Hexafluoroisopropanol (C₃H₂F₆O); formic acids; ethyl formate; acetic acid; Hexafluoroisopropanol (HFIP); cyclic ethers (such as THF, DMF, and PDO); acetone; acetates of C2 to C5 alcohol (such as ethyl acetate and t-butylacetate); glyme; methyl ethyl ketone; dipropyleneglycol methyl ether; lactones; 1,3-diocilane; 1,3-dioxolane2-one; ethyl carbonate; dimethlycarbonate; benzene; toluene; benzyl alcohol; p-xylene; naphthalene; tetrahydrofuran; N-methyl pyrrolidone; dimethylformamide; chloroform; 1,2-dichloromethane; morpholine; dimethylsulfoxide; hexafluoroacetone sesquihydrate (HFAS); anisole; and mixtures thereof.

Pressing the exposed surfaces of the polymer bodies together can be performed in any manner to practice the invention. The force applied during bonding should be large enough to provide consistent bond yield, and small enough not to mechanically damage the polymer bodies and/or any features that may be present on the polymer bodies. Typical bonding forces range from about 0.1 N/cm² to about 100 N/cm².

Polymer structures including a vapor exposure solvent bond are also provided by the invention. Due to the precise control of solvent exposure provided by the invention, very shallow and well-defined solvent bonds are provided. More specifically, a depth of the resulting solvent bond in the polymer bodies is preferably between about 10 nm and about 1 μm. Since the preferred solvent bond depth is less than about a micron at each of the bonded surfaces, the invention is especially applicable to bonding of micro-patterned polymer bodies. As indicated above, solvent bonding has not been regarded as suitable for bonding micro-patterned polymers, presumably because of the tendency for exposure to solvent to degrade or even destroy micro-pattern features. However, the solvent exposure accuracy and precision provided by the present invention overcome this problem. Thus micro-patterned polymers (e.g., having feature sizes in a range from about 10 nm to about 400 μm) can be bonded according to the invention without damage to the micro-pattern.

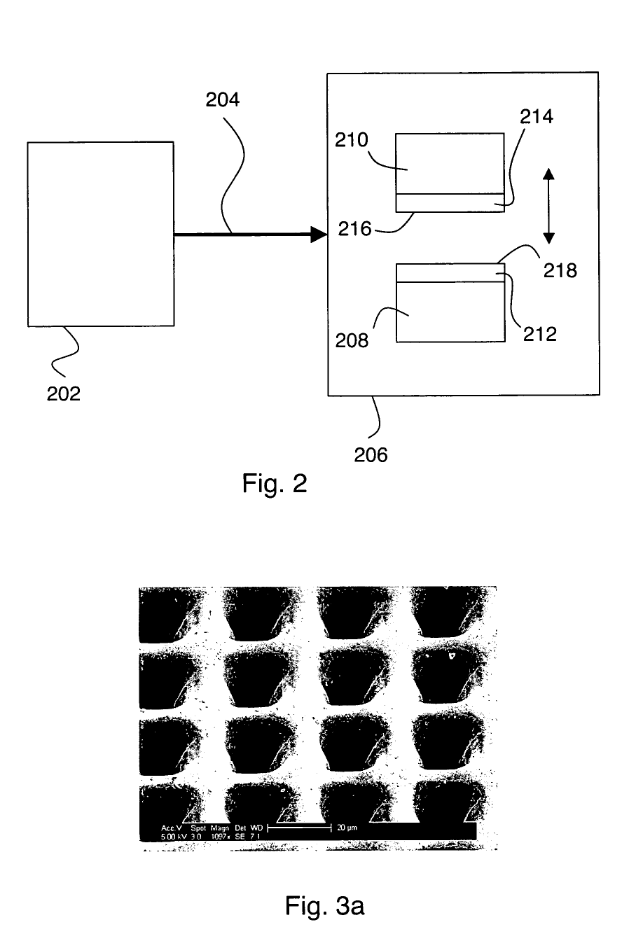

FIG. 2 shows apparatus for polymer solvent bonding according to an embodiment of the invention. A solvent vapor source 202 (e.g. an evaporation chamber) provides solvent vapor to a vapor chamber 206 via an input 204. Solvent vapor source 202 preferably provides a controlled flow rate and a controlled solvent vapor partial pressure to vapor chamber 206. Within vapor chamber 206, polymer bodies 212 and 214, having facing surfaces 218 and 216 respectively are disposed such that they can be pressed together by a press. In this example, the press has supports 208 and 210 which can be moved together. Other mechanical elements of the press are not shown, since any kind of press can be used to practice the invention. At least one of supports 208 and 210 is movable, but it is not necessary for both to be movable. Thus one support can be fixed (e.g., affixed to a wall of vapor chamber 206) in an alternative embodiment of the invention.

Vapor chamber 206 can be a full enclosure having well-defined inlets and outlets. Alternatively, vapor chamber 206 can be a partial enclosure providing sufficient control of solvent vapor partial pressure. For example, such a partial enclosure can be used on an assembly line where polymer bodies to be bonded are automatically fed to vapor chamber 206 and bonded therein. The choice between a full enclosure and partial enclosure can be made by an art worker upon consideration of tradeoffs involving process speed and control of process parameters.

Relevant process parameters include the temperatures of the surfaces 216 and 218, the exposure time during which these surfaces are exposed to solvent vapor, the time during which the surfaces are pressed together, the pressure with which the surfaces are pressed together, the flow rate of the solvent vapor, the partial pressure of the solvent vapor, and the temperature of vapor chamber 206.

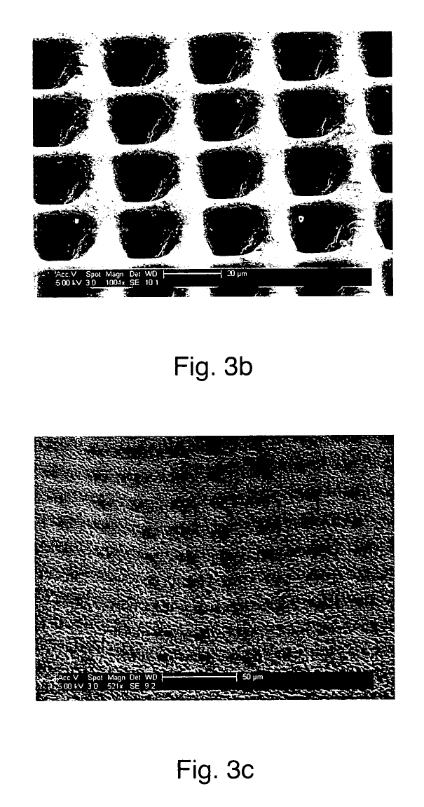

FIGS. 3a-c show examples of micro-patterned polymers exposed to solvent according to embodiments of the invention. FIG. 3a shows a control sample that has not been exposed to solvent vapor. FIG. 3b shows a sample that has been exposed to solvent vapor having a partial pressure of 40 Torr for 2 seconds. In the sample of FIG. 3b, minimal dissolution of sample features is present. FIG. 3c shows a sample that has been exposed to solvent vapor having a partial pressure of 71 Torr for 2 seconds. In the example of FIG. 3c, the micro-pattern is substantially destroyed. In all three cases the polymer is poly-dioxanone (PDS), the solvent is hexafluoroisopropanol (HFIP), and the sample temperature during exposure is 15 C. The parameters of the example of FIG. 3b correspond to linear regime solvent vapor exposure, while the parameters of the example of FIG. 3c correspond to saturated regime solvent vapor exposure.

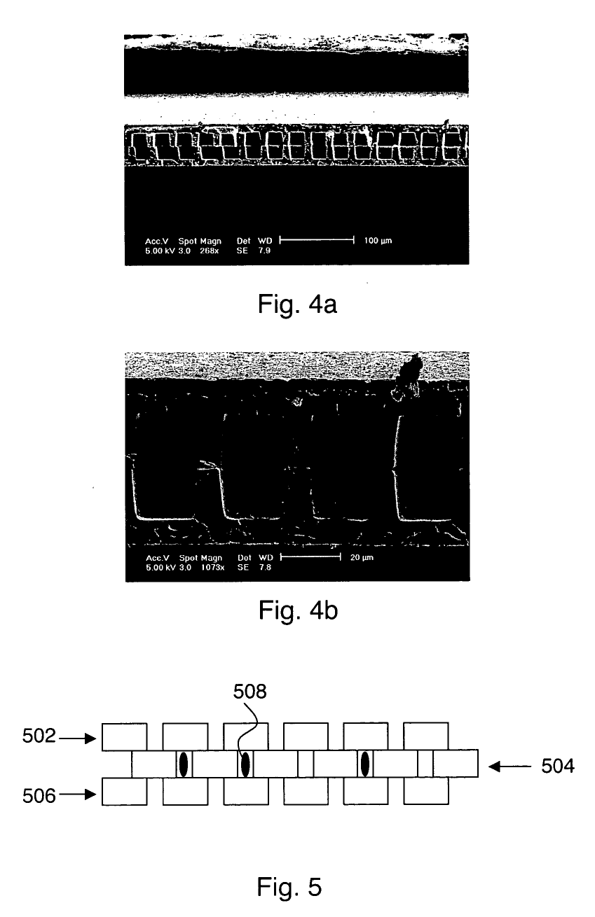

FIGS. 4a-b show an example of polymers bonded according to an embodiment of the invention. FIG. 4b is a higher magnification view of the structure of FIG. 4a. In this example, the polymer was PDS, the solvent was HFIP, and the sample temperature during pressing was 15 C. A linear regime exposure was performed (2 seconds at 40 Torr). Then the polymer surfaces were pressed together with a force of about 0.1 N/cm² and the solvent vapor was pumped out of the chamber. After about one minute the chamber was vented with air and the bonded polymer structure was released from the pressing unit. No degradation of the polymer micro-patterns is observable on FIGS. 4a-b. Furthermore, uniform bonding at the interface between patterned polymer layers is apparent in this example.

A noteworthy advantage of solvent bonding according to the present invention is that it can be performed at low temperatures and with a minimal amount of solvent. This advantage is especially relevant for applications dealing with temperature or solvent sensitive materials. Such materials can be the polymers being bonded and/or can be materials within inclusions present in polymer micro-patterns.

FIG. 5 shows a polymer structure having layers with inclusions and bonded according to an embodiment of the invention. In this example, polymer layers 502, 504, and 506 are bonded together to form a bonded polymer structure. This bonded polymer structure has inclusions 508 disposed in the micro-patterns of polymer layer 504. Inclusions 508 can be either biologically active or not biologically active. Inclusions 508 can be materials (e.g., drugs) and/or devices.

1. A method for polymer bonding, the method comprising:
a) providing a first polymer body having a first surface;
b) providing a second polymer body having a second surface;
c) exposing at least one of said first and second surfaces to a solvent vapor; and
d) pressing said first and second surfaces together after said exposing;
whereby said first and second polymer bodies are solvent bonded.

2. The method of claim 1, wherein said exposing comprises forming a liquid condensate of said solvent vapor on at least one of said first and second surfaces.

3. The method of claim 1, wherein said exposing comprises softening at least one of said first and second surfaces without forming a liquid condensate of said solvent vapor on said softened surface.

4. The method of claim 1, wherein said solvent vapor is a saturated vapor at a temperature of one of said first and second surfaces.

5. The method of claim 1, wherein said solvent vapor is an unsaturated vapor at a temperature of one of said first and second surfaces.

6. The method of claim 1, wherein said first and second surfaces are at substantially the same temperature during said exposing.

7. The method of claim 1, wherein said first and second surfaces are at different temperatures during said exposing.

8. The method of claim 1, wherein said solvent vapor comprises a solvent selected from the group consisting of: 1,4-Dioxane (C₄H₈O₂); 1,1,1,3,3,3-Hexafluoroisopropanol (C₃H₂F₆O); formic acids; ethyl formate; acetic acid; Hexafluoroisopropanol (HFIP); cyclic ethers (such as THF, DMF, and PDO); acetone; acetates of C2 to C5 alcohol (such as ethyl acetate and t-butylacetate); glyme; methyl ethyl ketone; dipropyleneglycol methyl ether; lactones; 1,3-diocilane; 1,3-dioxolane2-one; ethyl carbonate; dimethlycarbonate; benzene; toluene; benzyl alcohol; p-xylene; naphthalene; tetrahydrofuran; N-methyl pyrrolidone; dimethylformamide; chloroform; 1,2-dichloromethane; morpholine; dimethylsulfoxide; hexafluoroacetone sesquihydrate (HFAS); anisole; and mixtures thereof.

9. The method of claim 1, further comprising aligning features on said first polymer body to features on said second polymer body.

10. The method of claim 1, further comprising exposing said solvent bonded first and second polymer bodies to vacuum, whereby excess solvent is removed.

11. The method of claim 1, wherein said exposing comprises one or more control steps selected from the group consisting of controlling a temperature of said first surface, controlling a temperature of said second surface, controlling a time of said exposing, controlling a time of said pressing, controlling a pressure of said pressing, controlling a flow rate of said solvent vapor, and controlling a partial pressure of said solvent vapor.

12. The method of claim 1, wherein a vapor chamber is disposed around said first and second polymer bodies.

13. The method of claim 12, wherein said exposing comprises controlling a temperature of said vapor chamber.

14. A polymer structure comprising a first polymer body having a first surface and a second polymer body having a second surface, wherein said first and second polymer bodies are bonded to each other according to the method of claim 1 to provide a solvent bond.

15. The polymer structure of claim 14, wherein a depth of said solvent bond is between about 10 nm and about 1 μm in each of said first and second polymer bodies.

16. The polymer structure of claim 14, wherein said first and second polymer bodies are micro-patterned.

17. The polymer structure of claim 14, wherein at least one of said first and second polymer bodies includes features having dimensions in a range from about 10 nm to about 400 μm.

18. The polymer structure of claim 14, wherein at least one of said first and second polymer bodies comprise a polymer selected from the group consisting of: poly methyl methacrylates; polyethylene; polystyrene; nylons; polyester; polyurethane; polyterafluoroethylene; poly vinyl chloride; poly carbonate; polypropylene; poly vinyl alcohol; poly-lactide; poly-glycolide; poly-dioxanone; aliphatic poly-ester; poly-caprolactone; poly-anhydrides; poly ortho esters; alkali derivatives of trimethylenecarbonate; δ-valerolactone; β-butyrolactone; γ-butyrolactone; ε-decalactone; hydrocybutyrate; hydroxyvalerate; 1,4-dioxepan-2-one; 1,5,8,12-tetraoxacyclotetradecane-7,14-dione; 1,5-dioxepan-2-one; 6,6-dimethyl-1,4-diocan-2-one; and mixtures or co-polymers thereof.

19. The polymer structure of claim 14, wherein at least one of said first and second polymer bodies comprise a micro-pattern having inclusions in features of said micro-pattern

20. The polymer structure of claim 19, wherein said inclusions comprise a bio-active material, a non bio-active material, one or more bio-active devices, or one or more non bio-active devices.

21. An apparatus for bonding a first polymer body having a first surface to a second polymer body having a second surface, the apparatus comprising:
a) a vapor chamber around said first and second polymer bodies;
b) a vapor source providing a solvent vapor to said vapor chamber, wherein at least one of said first and second surfaces is exposed to said solvent vapor;
c) a press operatively connected to said first and second polymer bodies;
wherein said first and second surfaces are pressed together after exposure to said solvent vapor;
whereby said first and second polymer bodies are solvent bonded.

22. The apparatus of claim 21, wherein said vapor source comprises a solvent evaporation chamber providing flow rate and partial pressure control of said solvent vapor in said vapor chamber.
